(19) United States
(12) Patent Application Publication
(10) Pub. No.: US 2012/0032019 A1
(43) Pub. Date: Feb. 9, 2012

(54) ACTIVATING DEVICE FOR CORDLESS BLIND

(76) Inventor: Chin-Fu CHEN, Taichung (TW)

(21) Appl. No.: 12/876,761

(22) Filed: Sep. 7, 2010

(30) Foreign Application Priority Data
Aug. 5, 2010 (TW) 99215007

(51) Int. Cl. E05F 1/16; B65H 75/44; E05F 11/38; B65H 75/48

(52) U.S. Cl. 242/378; 242/372

(57) ABSTRACT

An activating device for a cordless blind includes a driving reel, a first transmission reel rotatable by the actuation of a cord connected between the driving reel and the transmission reel, and a second transmission reel rotatable by an actuation of a constant torque spring connected between the first and second transmission reels. As a result, when the cordless blind is lowered, the driving reel can be driven to rotate by two strings, which in turn leads a rotation of the first transmission reel by the cord and a rotation of the second transmission reel by the constant torque spring. When the cordless blind is lifted, the first and second transmission reels can be driven to rotate reversely and synchronously by the rebound force of the constant torque spring, causing the driving reel to rotate reversely through the cord.

### BACKGROUND OF THE INVENTION

1. Field of the Invention

The present invention relates generally to a cordless blind, and more specifically to an activating device attached to a cordless blind to raise or lower the cordless blind body without using an external pulling cord.

2. Description of the Related Art

Conventional window blinds generally include two types, i.e. a cord controlled type, which has an external cord to operate it, and a cordless controlled type, which is equipped with an activating device to raise or lower it, such as the one disclosed in Taiwan Pat. publication No. 263877 or Taiwan Pat. publication No. 322458.

However, in many instances in the prior art, the activating device has a complicated design and may cause an unsmooth operation, and therefore the issue of how to improve the structure of the conventional activating device for use in cooperation with the cordless blind and to enhance the efficiency of its use is always the manufacturer's concern.

### SUMMARY OF THE INVENTION

It is one objective of the present invention to provide an activating device for a cordless blind, which has a simple structure, and is efficient in operation.

To achieve this objective of the present invention, the activating device provided by the present invention comprises a bracket, a driving reel rotatably connected with the bracket, a first transmission reel unit having a first transmission reel rotatably mounted with the bracket, and a cord wound around the first transmission reel and having two ends respectively connected with the driving reel and the first transmission reel such that the first transmission reel is rotatable along with the driving reel through the cord, and a second transmission reel unit having a second transmission reel rotatably connected with the bracket, and a constant torque spring wound around the second transmission reel and having two ends respectively connected with the first transmission reel and the second transmission reel such that the second transmission reel and the first transmission reel are rotated simultaneously through the constant torque spring.

When a cordless blind, in which the activating device of the present invention is installed, is gradually lowered, the first transmission reel is driven by the rotation of the driving reel to rotate through the cord, and meanwhile the second transmission reel is driven by the rotation of the first transmission reel through the constant torque spring until the cordless blind is fully extended. On the contrary, when the cordless blind is gradually lifted, the first transmission reel and the second transmission reel are rotated reversely by the rebound force generated by the constant torque spring, and meanwhile the driving reel is driven to rotate reversely by the first transmission reel thought the cord until the cordless blind is folded.

By means of the aforesaid design, the activating device of the present invention can control the elevation of the cordless blind through cooperation of the reels, the cord, and the constant torque spring, so as to have the advantages of simple structure and convenient operation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded view of an activating device according to a preferred embodiment of the prevent invention;

FIG. 2 is a partial sectional view of a cordless blind in which an activating device according to the preferred embodiment of the prevent invention in installed, showing the window covering is folded;

FIGS. 3 is similar to FIG. 2, showing the window covering is unfolded; and

FIG. 4 is similar to FIG. 3, showing the window covering is gradually folded.

### DETAILED DESCRIPTION OF THE INVENTION

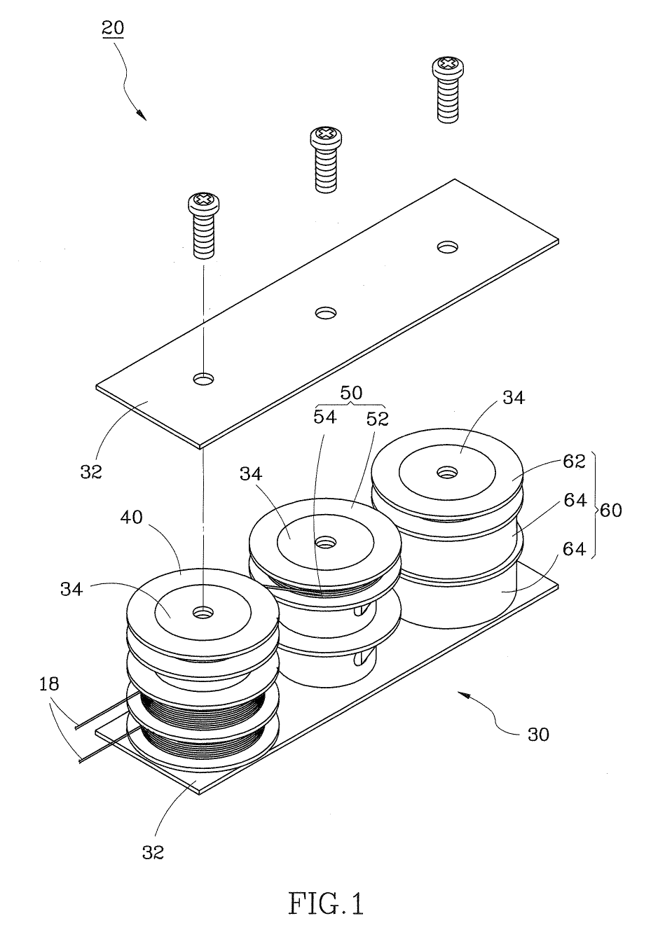

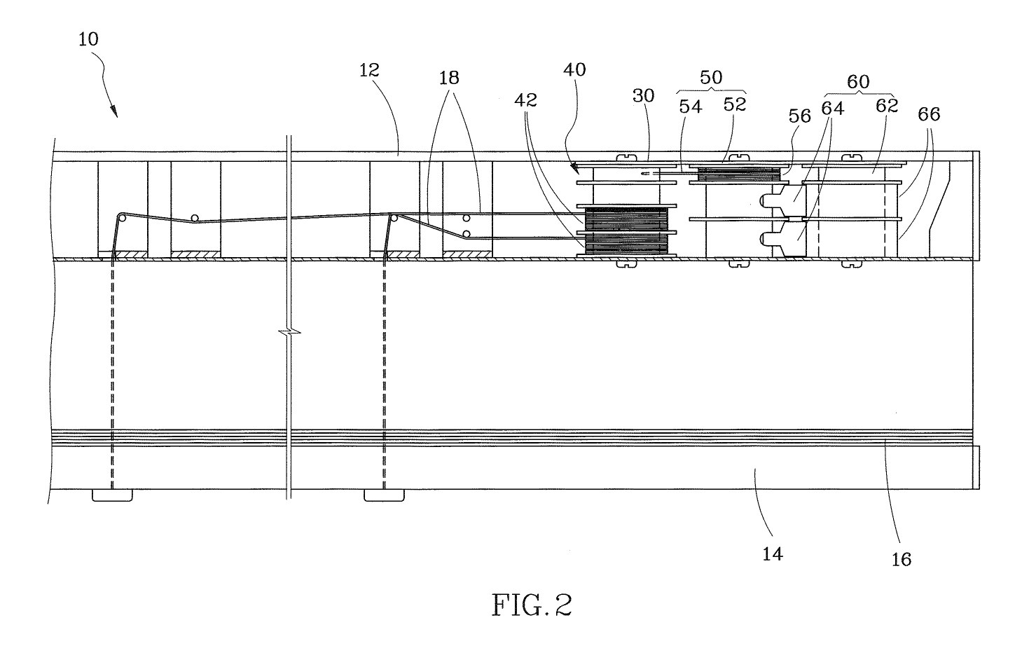

As shown in FIGS. 1 and 2, an activating device 20 in accordance with a preferred embodiment of the present invention is installed in a cordless blind 10. In this embodiment, the cordless blind 10 includes a head rail 12, a bottom rail 14 equipped with a plurality of balance weights (not shown), a window covering 16 disposed between the head rail 12 and the bottom rail 14, and two strings 18 each passing through the window covering 16 and having one end connected with the bottom rail 14 and the other end received in the head end 12. The activating device 20 comprises a bracket 30, a driving reel 40, a first transmission reel unit 50, and a second transmission reel unit 60.

The bracket 30 includes two retaining plates 32 spacedly fastened to the head rail 12, and three shafts 34 fastened between the retaining plates 32.

The driving reel 40 is rotatably sleeved on one of the shafts 34 of the bracket 30 and provided with two adjacent annular first grooves 42. The strings 18 are connected with the driving reel 40 in a way that the strings 18 are respectively wound around one of the first grooves 42 of the driving reel 40.

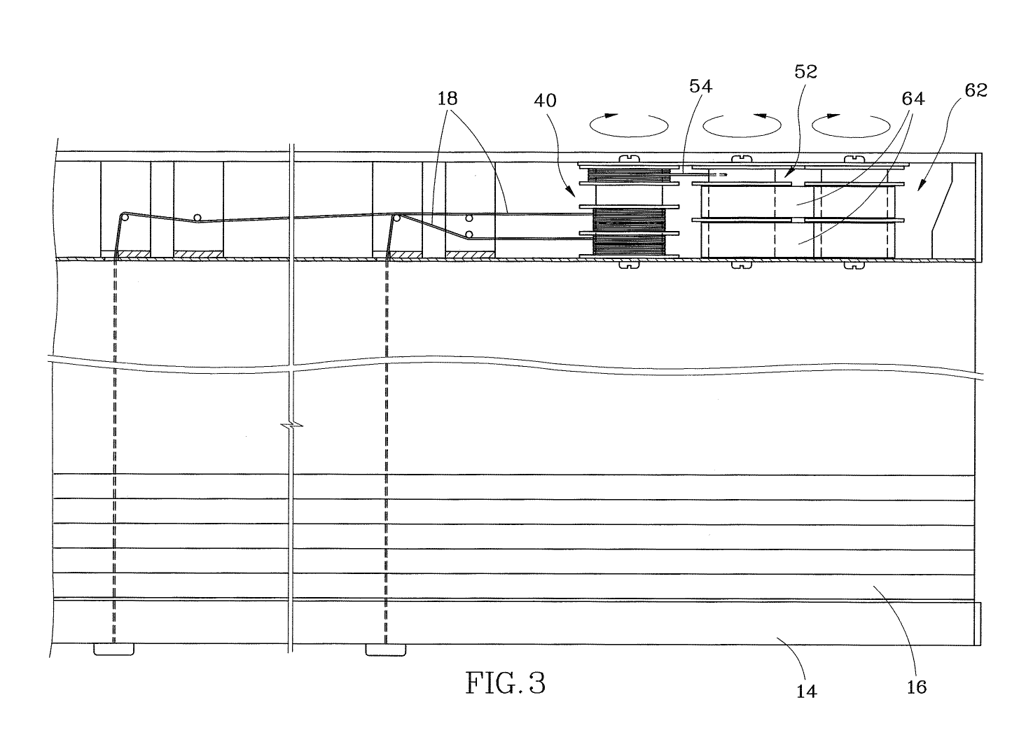

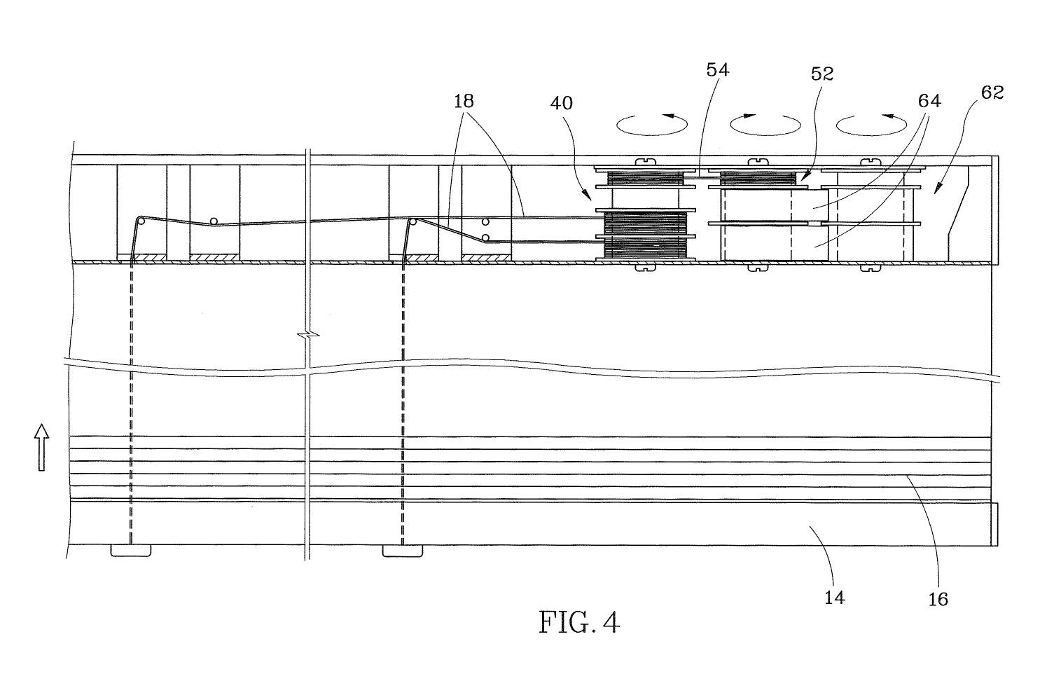

The first transmission reel unit 50 includes a first transmission reel 52 rotatably sleeved on another one of the shafts 34 of the bracket 30 and has an annular second groove 56, and a cord 54 having one end fixedly connected with the driving reel 40 and the other end fixedly connected with the first transmission reel 52 such that the cord 54 can be wound around the second groove 56 of the first transmission reel 52, as shown in FIGS. 1 and 2, or the driving reel 40, as shown in FIG. 3, or both as shown in FIG. 4.

The second transmission reel unit 60 includes a second transmission reel 62 rotatably sleeved on the other one of the shafts 34 of the bracket 30 and provided with two annular third grooves 66, and two constant torque springs 64 each having one end fixedly connected with the first transmission wheel 52 and the other end fixedly connected with the second transmission reel 62, such that the two constant torque springs 64 can be respectively wound around the third grooves 66 of the second transmission reel 62 or the first transmission reel 52 or both.

The structure of the activating device 20 is described as above, and the cooperation of the activating device 20 of the present invention and the cordless blind 10 is outlined hereinafter.

When a user pulls downwards the bottom rail 14 to lower the window covering 16, the driving reel 40 is rotated by the pulling force of the strings 18, resulting in that the first transmission reel 52 will be driven to rotate through the cords 54, which in turn will drive the second transmission reel 62 to rotate through the constant torque springs 64. Once the window covering 16 is fully extended and the user stops from pulling the bottom rail 14, the window covering 16 will stay in a state of static equilibrium because the total weight of the balance weights installed in the bottom rail 14 and the rebound force generated by the constant torque springs 64 are balanced, keeping the window covering 16 rested in a desired position, e.g. a fully extended position as shown in FIG. 3.

When the user pushes upwards the bottom rail 14 to retract the window covering 16, as shown in FIG. 4, the first and second transmission reels 52 and 62 are driven to rotate reversely and synchronously by the sum of the rebound forces generated by the constant torque springs 64 and the pushing force applied by the user, and therefore the driving reel 40 can be driven to rotate reversely by the cord 54 during the rotation of the first transmission reel 52, such that the strings 18 can be wound around the driving reel 40 to gradually fold the window covering 16. When the window covering 16 is totally folded and the user stops from pushing the bottom rail 14, the window covering 16 will stay in static equilibrium status since the total weight of the balance weights and the rebound force generated by the constant torque springs 64 are equal, keeping the window covering 16 rested in a desired position, e.g. a fully folded position as shown in FIG. 2.

Accordingly, the activating device of the present invention is configured to lift or lower the blind covering by the cooperation of the three reels, the cord, and the constant torque springs, that is to say, the activating device of the present invention has the advantages of simple structure and efficient operation.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An activating device for a cordless blind having a head rail, a bottom rail suspended from the head rail by two strings, and a window covering disposed between the head rail and the bottom rail, the activating device comprising:
a bracket mounted with the head rail;
a driving reel rotatably mounted with the bracket for connection and winding of the strings;
a first transmission reel unit having a first transmission reel rotatably connected with the bracket, and a cord wound around the first transmission reel and having two ends respectively connected with the driving reel and the first transmission reel; and
a second transmission reel unit having a second transmission reel rotatably connected with the bracket, and at least one constant torque spring wound around the second transmission reel and having two ends respectively connected with the first transmission reel and the second transmission reel.

2. The activating device as claimed in claim 1, wherein the bracket includes two retaining plates spacedly fastened to the head rail, and three shafts fastened between the retaining plates for installation of the driving reel, the first transmission reel, and the second transmission reel.

3. The activating device as claimed in claim 1, wherein the driving reel has two grooves for accommodation of the strings.

4. The activating device as claimed in claim 1, wherein the cord of the first transmission reel unit is wound around a groove of the first transmission reel.

5. The activating device as claimed in claim 1, wherein the at least one constant torque spring is received in at least one groove of the second transmission reel.

6. The activating device as claimed in claim 5, comprising two said constant torque springs and two said groves of the second transmission reel.
